(19) United States
(12) Patent Application Publication
(10) Pub. No.: US 2026/0336921 A1
(43) Pub. Date: Oct. 29, 2026

(54) PORTABLE MANUAL WASTE CONTAINER

(71) Applicant: Jiangsu Wellspring PET Articles Co., Ltd., Yancheng (CN)

(72) Inventor: Bin QIU, Yancheng (CN)

(21) Appl. No.: 19/417,908

(22) Filed: Dec. 12, 2025

(30) Foreign Application Priority Data
Apr. 27, 2025 (CN) 202510539265.7

(51) Int. Cl. B65F 1/06; B65F 1/10; B65F 1/16

(52) U.S. Cl. CPC B65F 1/062; B65F 1/10; B65F 1/16

(57) ABSTRACT

Provided is a portable manual waste container, including: a container body; a lid rotatably connected to an end of the container body; a first fixing member connected to an inner wall of the container body, a recessed groove being provided on a side of the first fixing member adjacent to the lid; a second fixing member extending through a bottom of the recessed groove and connected to the first fixing member, the second fixing member being provided with a through hole; a driving assembly connected to the lid and the first fixing member; and a limiting assembly connected to the first fixing member.

### CROSS REFERENCE TO THE RELATED APPLICATIONS

This application is based upon and claims priority to Chinese Patent Application No. 202510539265.7, filed on Apr. 27, 2025, the entire contents of which are incorporated herein by reference.

### TECHNICAL FIELD

The present disclosure relates to the field of pet products, and specifically to a portable manual waste container.

### BACKGROUND

With the gradual improvement of modern living standards, more and more people are keeping pets. A pet owner usually disposes of the excrement of a pet in a waste container and closes the lid of the waste container to reduce the spread of unpleasant smell. However, once the lid of the waste container is opened again, the accumulated excrement in the waste container will cause a strong unpleasant smell. When a user uses a shovel to clean up the excrement, the user usually opens the lid of the waste container first in order to put the excrement into the waste container easily. Then, after putting all the excrement into the waste container, the user closes the lid of the waste container. During the opening of the lid of the waste container, unpleasant smell spreads from inside the waste container and causes discomfort to the user.

### SUMMARY

An objective of the present disclosure is to provide a portable manual waste container to solve the technical problem of conventional waste containers for pets that unpleasant smell spreads and causes discomfort to the user during the opening of the lid of the waste container.

To achieve the above objective, an embodiment of the present disclosure provides a portable manual waste container, including:
a container body;
a lid, where the lid is rotatably connected to an end of the container body;
a first fixing member, where the first fixing member is connected to an inner wall of the container body, and a recessed groove is provided on a side of the first fixing member adjacent to the lid;
a second fixing member, where the second fixing member extends through a bottom of the recessed groove and is connected to the first fixing member, and the second fixing member is provided with a through hole;
a driving assembly, where the driving assembly is connected to the lid and the first fixing member; and
a limiting assembly, where the limiting assembly is connected to the first fixing member.

In the above technical solution, the container body includes:
a first housing, where a first accommodating cavity is provided in the first housing; and
a second housing, where the second housing is rotatably connected to the first housing, a second accommodating cavity is provided in the second housing, and the second accommodating cavity is in communication with the first accommodating cavity.

In the above technical solution, the driving assembly includes:
two first connection members, where the two first connection members are arranged in the second accommodating cavity and are connected to the lid, and the two first connection members are located at a connection between the lid and the second housing;
a rotating shaft, where the rotating shaft is connected to the two first connection members;
a sliding member, where the sliding member is slidably connected to an outer wall of the first fixing member, a slide groove is provided on a side of the sliding member adjacent to the first fixing member, and the rotating shaft is slidably connected to an interior of the slide groove; and
two second connection members, where the two second connection members are respectively connected to two sides of the sliding member.

In the above technical solution, the limiting assembly includes:
two first limiting members, where the two first limiting members are rotatably connected to the first fixing member symmetrically, and are respectively arranged on the two sides of the sliding member;
two second limiting members, where each of the two second limiting members is connected to a side of a respective one of the two first limiting members adjacent to the sliding member, and the two second limiting members respectively correspond to the two second connection members; and
a spring, where two ends of the spring are respectively connected to the two second limiting members.

In the above technical solution, the portable manual waste container further includes:
a third fixing member, where the third fixing member is rotatably connected to the second housing and is arranged between the lid and the first fixing member.

In the above technical solution, the portable manual waste container further includes:
a cutting member, where the cutting member is connected to the second housing.

Additional aspects and advantages of the present disclosure will be apparent from the description below, or understood through practice of the present disclosure.

### BRIEF DESCRIPTION OF THE DRAWINGS

The above and/or other additional aspects and advantages of the present disclosure become apparent and comprehensible from the description of embodiments made in connection with the accompanying drawings, in which:

FIG. 1 is a schematic view of an overall structure of the present disclosure.

FIG. 2 is a schematic structural rear view of the present disclosure.

FIG. 3 is a schematic structural cross-sectional view of the present disclosure.

FIG. 4 is a schematic structural enlarged view of part A of the present disclosure.

FIG. 5 is a schematic structural view of the present disclosure when a lid and a third fixing member are open.

FIG. 6 is a schematic structural view of the present disclosure when the lid is open and the third fixing member is closed.

FIG. 7 is a schematic structural view of a driving assembly and a limiting assembly of the present disclosure.

FIG. 8 is a schematic structural view of the limiting assembly of the present disclosure.

### DETAILED DESCRIPTION OF THE EMBODIMENTS

To make the objectives, features, and advantages of the present disclosure more comprehensible, the present disclosure will be described in detail below with reference to the accompanying drawings and specific embodiments. It should be noted that the embodiments of the present disclosure and the features in the embodiments may be combined with each other without conflict.

Many specific details are set forth in the following description to provide a full understanding of the present disclosure. However, the present disclosure can also be implemented in other ways different from those described herein, so the scope of protection of the present disclosure is not limited by the specific embodiments disclosed below.

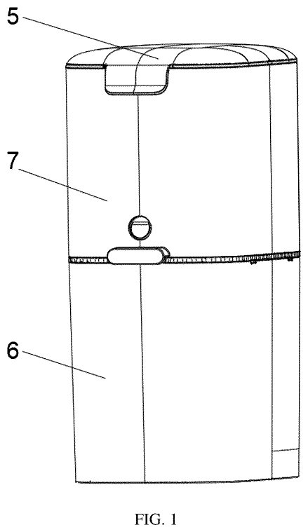

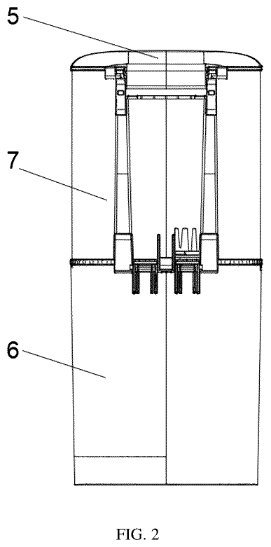

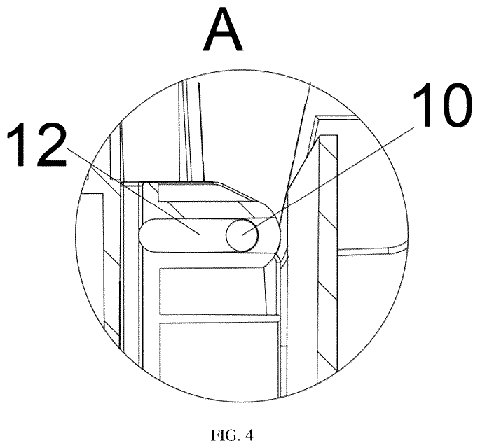

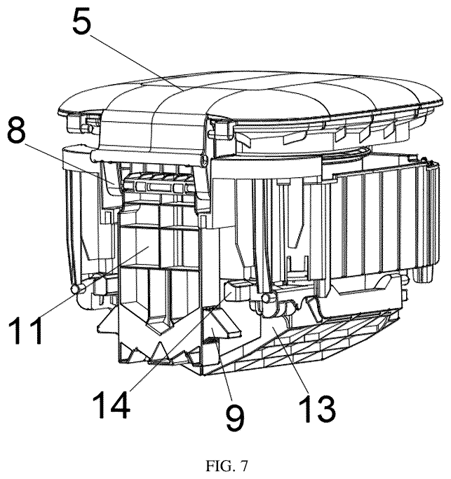

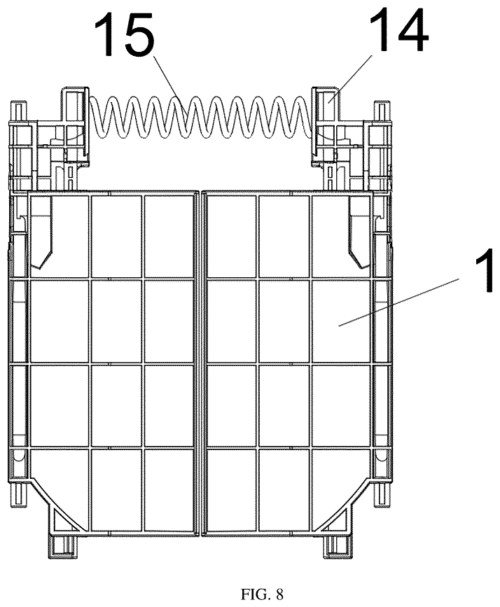

A portable manual waste container according to some embodiments of the present disclosure will be described below with reference to FIG. 1 to FIG. 8.

As shown in FIG. 1 to FIG. 8, an embodiment of the present disclosure provides a portable manual waste container, which includes a container body, a lid 5, a first fixing member 1, a second fixing member 2, a driving assembly, and a limiting assembly.

Specifically, the lid 5 is rotatably connected to an upper end of the container body. The first fixing member 1 is connected to an inner wall of the container body. A recessed groove 3 is provided on an upper surface of the first fixing member 1. The second fixing member 2 extends through a bottom of the recessed groove 3 and is fixedly connected to the first fixing member 1. The second fixing member 2 is provided with a through hole 4 in a vertical direction. The driving assembly is connected to the lid 5 and the first fixing member 1. The limiting assembly is connected to the first fixing member 1.

To use the waste container, an elongated cylindrical garbage bag is sleeved over an outer side of the second fixing member 2. A length of the garbage bag is much greater than a length of the second fixing member 2 in the vertical direction, so that the garbage bag can be sleeved over the outer side of the second fixing member 2 in a bent manner. Then, an upper end of the garbage bag is pulled to enter the through hole 4 through an upper end of the through hole 4 and then exit the through hole 4 through a lower end of the through hole 4. Then, the garbage bag is further pulled downward by a distance. Finally, the end portion of the garbage bag passing through the through hole 4 is tied up, thus completing the mounting of the garbage bag.

When the lid 5 is in a closed state, the lower end of the through hole 4 is blocked by the limiting assembly. To open the lid 5, a front end of the lid 5 is lifted upward, so that the lid 5 rotates along the connection between a rear end of the lid 5 and the upper end of the container body. During the rotation of lid 5, the driving assembly is driven to move upward. As the driving assembly moves upward, the driving assembly drives the limiting assembly to move, so that the lower end of the through hole 4 is no longer blocked by the limiting assembly. As the driving assembly further moves upward and is no longer in contact with the limiting assembly, the limiting assembly returns to an original position and blocks the lower end of the through hole 4 again. In this case, the lid 5 is in an open state. As such, when the lid 5 is in the open state, excrement in the garbage bag is located below the through hole 4, and unpleasant smell from the excrement is blocked by the limiting assembly, so that the impact of the unpleasant smell on people is reduced. Then, excrement removed with a shovel is placed in the through hole 4, so that the excrement falls to above the limiting assembly.

To close the lid 5, the lid 5 is pushed downward, so that the lid 5 rotates along the connection between the rear end of the lid 5 and an upper end of the lid 5. During the rotation of the lid 5, the lid 5 drives the driving assembly to move downward. As the driving assembly moves downward, the driving assembly drives the limiting assembly to move, so that the lower end of the through hole 4 is no longer blocked by the limiting assembly, and excrement falling to above the limiting assembly falls downward to below the limiting assembly. After the driving assembly moves downward to an initial position, the driving assembly is no longer in contact with the limiting assembly, and the limiting assembly returns to the original position and blocks the lower end of the through hole 4 again. As such, all the excrement is located below the limiting assembly and there is no excrement in the through hole 4.

During opening and closing of the lid 5, the limiting assembly is opened twice briefly, so that the spread of unpleasant smell of excrement can be avoided. As such, even if the lid 5 is fully open, the unpleasant smell of excrement will not affect the environment and the user.

It should be noted that the first fixing member 1 may be fixedly or detachably connected to the inner wall of the container body. When the first fixing member 1 is detachably connected to the inner wall of the container body, the first fixing member 1 can be applied to different waste containers. The use of a garbage bag in the different waste containers mentioned herein needs to be based on the same principle as the use of a garbage bag in the present disclosure, so that the use range of the first fixing member 1 is expanded.

As shown in FIG. 1 to FIG. 8, in an embodiment of the present disclosure, the container body includes:
a first housing 6, where a first accommodating cavity is provided in the first housing 6; and
a second housing 7, where the second housing 7 is rotatably connected to an upper end of the first housing 6, a second accommodating cavity is provided in the second housing 7, the second accommodating cavity is in communication with the first accommodating cavity, and the lid 5 is rotatably connected to an upper end of the second housing 7.

The driving assembly includes:
two first connection members 8, where the two first connection members 8 are arranged in the second accommodating cavity and are fixedly connected to the lid 5, and the two first connection members 8 are located below a connection between the lid 5 and the second housing 7;
a rotating shaft 10, where two ends of the rotating shaft 10 are fixedly connected to the two first connection members 8 respectively, and the rotating shaft 10 is arranged at lower ends of t he two first connection members 8;
a sliding member 11, where the sliding member 11 is slidably connected to an outer wall of the first fixing member 1, an upper end of the sliding member 11 is arranged between the two first connection members 8, a slide groove 12 is provided on a side of the sliding member 11 adjacent to the first fixing member 1, and the rotating shaft 10 is slidably connected to an interior of the slide groove 12; and
two second connection members 9, where the two second connection members 9 are fixedly connected to two sides of the sliding member 11 respectively.

The limiting assembly includes:
two first limiting members 13, where the two first limiting members 13 are rotatably connected to a lower end of the first fixing member 1 symmetrically, and are respectively arranged on the two sides of the sliding member 11;
two second limiting members 14, where each of the two second limiting members 14 is fixedly connected to a side of a respective one of the two first limiting members 13 adjacent to the sliding member 11, and the two second limiting members 14 respectively correspond to the two second connection members 9; and
a spring 15, where two ends of the spring 15 are fixedly connected to the two second limiting members 14 respectively, and the spring 15 is configured to cause the two first limiting members 13 to be in contact with each other in an initial state.

To open the lid 5, the lid 5 is lifted upward, so that the lid 5 rotates. During the rotation of the lid 5, the lid 5 drives the first connection members 8 to rotate, so that the lower ends of the first connection members 8 move upward while approaching the first fixing member 1, causing the rotating shaft 10 to move upward while gradually approaching the first fixing member 1 along the slide groove 12. The upward movement of the rotating shaft 10 drives the sliding member 11 to move upward. The upward movement of the sliding member 11 drives the second connection members 9 fixedly connected to the two sides of the sliding member 11 to move upward. During the upward movement of each second connection member 9, because each second connection member 9 is located below the respective second limiting member 14, the second connection member 9 gradually approaches the second limiting member 14. When the second connection member 9 comes into contact with the second limiting member 14 and continues to move upward, the second connection member 9 pushes the second limiting member 14 to move upward. Because each second limiting member 14 is fixedly connected to the respective first limiting member 13, and an end of each first limiting member 13 adjacent to an inner wall of the first accommodating cavity is rotatably connected to the lower end of the first fixing member 1, the second limiting member 14 drives the first limiting member 13 to rotate. Before the second connection member 9 comes into contact with the second limiting member 14, respective ends of the two first limiting members 13 away from the inner wall of the first accommodating cavity are in contact with each other and block the lower end of the through hole 4. Therefore, as the first limiting members 13 rotate, respective ends of the two first limiting members 13 away from the inner wall of the first accommodating cavity move upward and away from each other, so that the through hole is no longer blocked by the two first limiting members 13. As the second connection member 9 continues to move upward, the second connection member 9 pushes the second limiting member 14 to move toward the inner wall of the first accommodating cavity, until the second connection member 9 is no longer obstructed by the second limiting member 14. As the two second limiting members 14 move upward and away from each other, the spring 15 is stretched. Therefore, when the second connection members 9 move to above the second limiting members 14 respectively and are no longer in contact with the second limiting members 14 respectively, the spring 15 restores to an original shape and drives the first limiting members 13 to return to an original position, so that the lower end of the through hole 4 is blocked by the two first limiting members 13 again. Then, the lid 5 is released. After the release of the lid 5, the second connection members 9 rest above the second limiting members 14 respectively, and the lid 5 is in an open state due to a restoring force of the spring 15. In this case, excrement may be placed into the through hole 4. The garbage bag is divided into two spaces by the first limiting members 13, and the excrement is placed inside the garbage bag above the first limiting members 13.

After the excrement is placed, the lid 5 is pushed downward, so that the lid 5 rotates to drive the first connection members 8 to return to an original position. During this process, the first connection members 8 drive the sliding member 11 to move downward. The downward movement of the sliding member 11 drives the second connection members 9 to move downward. The downward movement of the second connection members 9 drives the second limiting members 14 to move downward and toward the inner wall of the first accommodating cavity, thus stretching the spring 15. Meanwhile, the first limiting members 13 rotate, so that the respective ends of the two first limiting members 13 away from the inner wall of the first accommodating cavity move away from each other, and the excrement falls into the garbage bag below the two first limiting members 13 from between the two first limiting members 13. When the second connection members 9 move to below the second limiting members 14 respectively, the second connection members 9 are no longer obstructed by the second limiting members 14, and the spring 15 restores to an original shape and drives the second limiting members 14 and the first limiting members 13 to move, so that the two first limiting members 13 come into contact with each other to block the lower end of the through hole 4 again. In this case, the lid 5 is closed, and there is no excrement above the first limiting members 13.

In the above process, during opening or closing of the lid 5, the first limiting members 13 are in an open state only for a short moment, so that the spread of unpleasant smell of excrement below the first limiting members 13 can be avoided, thereby reducing the impact on the environment and people.

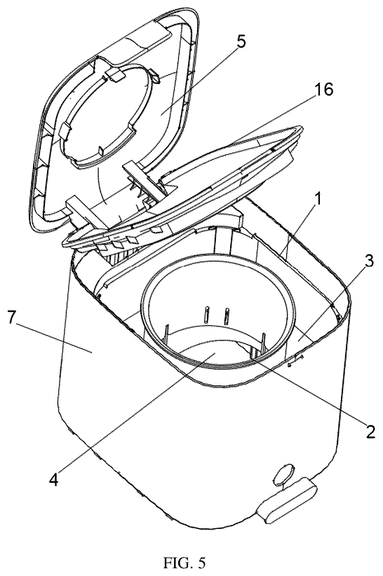

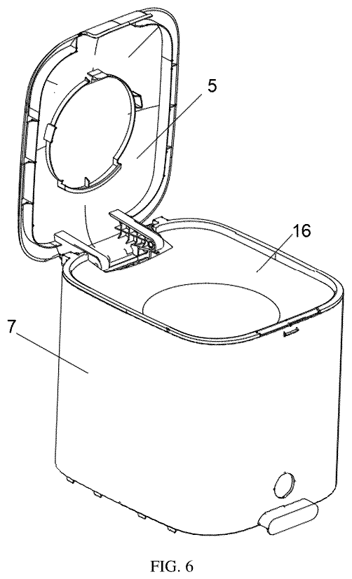

As shown in FIG. 5 and FIG. 6, in an embodiment of the present disclosure, the portable manual waste container further includes:
a third fixing member 16, where the third fixing member 16 is rotatably connected to the second housing 7 and is arranged between the lid 5 and the first fixing member 1, and the third fixing member 16 has a hollow structure at a middle portion thereof in the vertical direction, and the hollow structure corresponds to the through hole 4.

When a garbage bag needs to be mounted, the third fixing member 16 may be turned upward. After the mounting of the garbage bag is completed, the third fixing member 16 may be turned downward. The garbage bag is pressed tightly through the engagement of the third fixing member 16 and the first fixing member 1 to prevent the garbage bag from shaking.

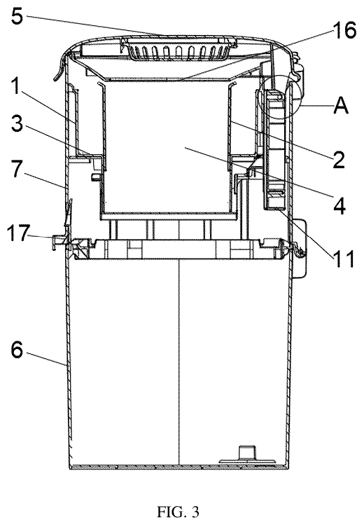

As shown in FIG. 3, in an embodiment of the present disclosure, the portable manual waste container further includes:
a cutting member 17, where the cutting member 17 is fixedly connected to a lower end of the second housing 7, and the cutting member 17 is a blade, which is sheathed with a protective shell, and the protective shell is fixedly mounted at a bottom of the second housing 7 to prevent the blade from being exposed to the outside and injuring the user.

When the lid 5 is in the closed state, a garbage bag passing through the through hole 4 is divided into a first space and a second space by the first limiting members 13. The first space is located above the first limiting members 13. The second space is located below the first limiting members 13. There is no excrement in the first space. The first space is located in the through hole 4. All the excrement is in the second space. The second space is located in the first accommodating cavity. When the second space is full of excrement, the second housing 7 may be lifted upward. Then, the garbage bag below the first limiting members 13 is cut with the blade. After the cutting is completed, the garbage bag in the through hole 4 is pulled downward, so that the garbage bag sleeved over the second fixing member 2 gradually passes through the through hole 4 and moves downward. When a length of the garbage bag extending into the first accommodating cavity is sufficient, a bottom of the garbage bag in the first accommodating cavity is tied up, and the second housing 7 is turned downward for continued use.

In addition, a soft material, such as foam cotton, is fixed at an end of each first limiting member 13 away from the inner wall of the first accommodating cavity. When the lower end of the through hole 4 is blocked by the first limiting members 13, the foam cotton on the two first limiting members 13 is in contact with each other to compress the garbage bag, so that the first space and the second space are not in communication with each other. As such, unpleasant smell inside the second space will not spread upward to affect the environment and people.

The present disclosure has the following advantages.

Through the cooperation of the driving assembly and the limiting assembly, when the lid 5 is fully open, unpleasant smell of excrement will not spread into the air and affect the environment and people. In addition, because the excrement is in contact with the air only for a short time during opening and closing of the lid 5, the impact of the unpleasant smell of the excrement to the environment and people is greatly reduced.

In the present disclosure, the terms such as “mount”, “connect”, “couple”, “fix”, and variants thereof should be interpreted in a broad sense. For example, “connection” may be a fixed connection, a detachable connection, or an integral connection; and “connection” may also be a direct connection or an indirect connection through an intermediate medium. For those of ordinary skill in the art, the specific meanings of the above terms in the present disclosure can be understood according to specific circumstances.

In the description of the present disclosure, it should be understood that the orientation or positional relationships indicated by the terms such as “inner” and “outer” are based on orientation or position relationships shown in the accompanying drawings, and are used only for ease and brevity of illustration and description, rather than indicating or implying that the mentioned apparatus or unit must have a particular orientation or must be constructed and operated in a particular orientation. Therefore, such terms should not be construed as limiting of the present disclosure.

In the description of this specification, the description with reference to the terms such as “an embodiment”, “some embodiments”, and “specific embodiment” means that specific features, structures, materials, or characteristics described in connection with the embodiment or example are embraced in at least one embodiment or example of the present disclosure. In this specification, exemplary descriptions of the foregoing terms do not necessarily refer to the same embodiment or example. Moreover, the described specific features, structures, materials, or characteristics may be combined in any suitable manner in one or more embodiments or examples.

The above description is merely preferred embodiments of the present disclosure, and is not intended to limit the present disclosure. To those skilled in the art, various modifications and variations may be made to the present disclosure. Any modification, equivalent replacement, or improvement made without departing from the spirit and principle of the present disclosure shall fall within the scope of protection of the present disclosure.

What is claimed is:

1. A portable manual waste container, comprising:
a container body;
a lid, wherein the lid is rotatably connected to an end of the container body;
a first fixing member, wherein the first fixing member is connected to an inner wall of the container body, and a recessed groove is provided on a side of the first fixing member adjacent to the lid;
a second fixing member, wherein the second fixing member extends through a bottom of the recessed groove and is connected to the first fixing member, and the second fixing member is provided with a through hole;
a driving assembly, wherein the driving assembly is connected to the lid and the first fixing member; and
a limiting assembly, wherein the limiting assembly is connected to the first fixing member.

2. The portable manual waste container according to claim 1, wherein
the container body comprises:
a first housing, wherein a first accommodating cavity is provided in the first housing; and
a second housing, wherein the second housing is rotatably connected to the first housing, a second accommodating cavity is provided in the second housing, and the second accommodating cavity is in communication with the first accommodating cavity.

3. The portable manual waste container according to claim 2, wherein
the driving assembly comprises:
two first connection members, wherein the two first connection members are arranged in the second accommodating cavity and are connected to the lid, and the two first connection members are located at a connection between the lid and the second housing;
a rotating shaft, wherein the rotating shaft is connected to the two first connection members;
a sliding member, wherein the sliding member is slidably connected to an outer wall of the first fixing member, a slide groove is provided on a side of the sliding member adjacent to the first fixing member, and the rotating shaft is slidably connected to an interior of the slide groove; and
two second connection members, wherein the two second connection members are respectively connected to two sides of the sliding member.

4. The portable manual waste container according to claim 3, wherein
the limiting assembly comprises:
two first limiting members, wherein the two first limiting members are rotatably connected to the first fixing member symmetrically, and are respectively arranged on the two sides of the sliding member;
two second limiting members, wherein each of the two second limiting members is connected to a side of a respective one of the two first limiting members adjacent to the sliding member, and the two second limiting members respectively correspond to the two second connection members; and
a spring, wherein two ends of the spring are respectively connected to the two second limiting members.

5. The portable manual waste container according to claim 4, further comprising:
a third fixing member, wherein the third fixing member is rotatably connected to the second housing and is arranged between the lid and the first fixing member.

6. The portable manual waste container according to claim 5, further comprising:
a cutting member, wherein the cutting member is connected to the second housing.
